(19) United States
(12) Patent Application Publication
(10) Pub. No.: US 2012/0002219 A1
(43) Pub. Date: Jan. 5, 2012

(54) PRINT SHOP MANAGEMENT METHOD AND PROGRAM FOR PRINTING MIXED COLOR AND BLACK AND WHITE DOCUMENTS

(75) Inventor: Naoki KOMINE, Hawthorne, CA (US)

(73) Assignee: KONICA MINOLTA SYSTEMS LABORATORY, INC., Huntington Beach, CA (US)

(21) Appl. No.: 12/826,933

(22) Filed: Jun. 30, 2010

(51) Int. Cl. H04N 1/60

(52) U.S. Cl. 358/1.9

(57) ABSTRACT

A method and computer program is described for managing a print shop system in which a plurality of color and black and white printers are connected to and managed by a computer. To print a source document having mixed color and black and white pages with a color-split printing process, the computer first execute a verification program to determine whether the source document indeed contains mixed color and black and black and white pages by utilizing a recursive pair-down or page-down scheme where the color values of the pages are compared and as soon as a mismatch in the color values of the processed pages occurs, the computer will return a result indicating that the source document indeed contains mixed color and black and white pages. Alternatively the computer will return a result indicating that the source document does not contain mixed color and black and white pages when a last page of the document is reached but a mismatch of the color value of the compared page never occurs.

### BACKGROUND OF THE INVENTION

1. Field of the Invention

This invention relates to a method and program for managing a print shop system in which a plurality of color and black and white (B/W) printers are connected to and managed by a server. In particular, it relates to a method and program of managing print jobs and printers in a print shop for color-split printing of documents that contain both color and B/W pages.

2. Description of Related Art

Modern professional print shops typically utilize a plurality of color and B/W printers connected to one or more servers by a network, where the servers control the printing of customer jobs on one or more color and/or B/W printers. The printers in a print shop typically have different characteristics and capabilities. In the past, documents containing only black and white pages (including gray level images) are typically printed by using B/W printers, and documents containing color pages are printed by using color printers.

Generally, printing jobs performed by color printers cost much more, but run much slower, than printing jobs performed by B/W printers. Therefore, it is preferable to print colored documents on color printers, and B/W documents on B/W printers. However, many documents nowadays are mixed with color and B/W pages. If such documents are sent to and printed by a B/W printer, then the color pages will also be printed black which is not acceptable. On the other hand, if such documents are sent to and printed by a color printer, the B/W pages will also be printed by the color printer which is a waste of resources and time.

Therefore, print shop management systems and programs have been developed to handle the printing of “mixed” documents that contain both color and black and white pages, by separating a “mixed” document into a “color” subset of color pages to be sent to and printed by a color printer, and a “B/W” subset of B/W pages to be sent to and printed by a B/W printer. Such a process is sometimes referred to as “color-split” printing, and the program implementing it is sometimes referred to as a “color-split” program.

A problem experienced by users of color-split printing happens when a user is printing a large volume documents assuming that it is a mixed document and sending it through a color-split program. If the document is indeed a mixed document containing both color and B/W pages, the color-split program will separate the pages into a color subset and a B/W subset, sending the color subset to a color printer and the B/W subset to a B/W printer. When the printing is done, the user goes to the color printer to collect the printed color pages and goes to the B/W printer to collect the B/W pages. If the document is actually not a mixed document, and for example contains only B/W pages, the color-split program will make only one B/W “subset” of pages (which actually are all the pages of the document) and send the subset to a B/W printer. However, when the user goes to the printers to collect the printed pages, there will be no page printed by the color printer. Without knowing that the document indeed contains no color page, the user is left to wonder whether there is some problem in the color printing process. It is very time consuming and ineffective for the user to go back to the original print job of the document to manually verify that it indeed contains no color pages, particularly if the volume of the document is very large and/or the document contains only a few color pages.

It would be preferable to have a procedure to quickly determine whether a document intended for color-split printing is indeed mixed with both color and B/W pages.

### SUMMARY

The present invention is directed to a print shop management method and program for determining whether a document intended for color-split printing is indeed a mixed document containing both color and black and white pages before the document is sent to the printers.

An object of the present invention is to provide a print shop management method and program, and a computer, a server or a printer implementing the method and program, that quickly verifies if a document intended for color-split printing indeed contains color and B/W pages. If the verification result is affirmative (i.e., the document indeed contains at least one color page), then the document will be processed through the color-split program to separate the pages into a color subset and a B/W subset so that the page(s) of the color subset will be sent to and printed by a color printer and the page(s) of the B/W subset will be sent to and printed by a B/W printer. If the verification result is negative (i.e., the document does not contain any color page), then the document will be directly sent to and printed by a B/W printer.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other objects, as embodied and broadly described, the present invention provides a method for managing a print shop system, the print shop system including a plurality of printers including one or more color printers and one or more black and white printers, the method being implemented on a computer connected to the printers. The method includes the steps of: (a) obtaining a source document to be printed, the source document including a plurality of pages each having a color value indicating whether the page is color or black and white; (b) ascertaining the color value of a first pair of pages, setting a first temporary variable to a value indicating color if at least one of the pages in the first pair is color, or setting the first temporary variable to a value indicating black and white if both pages in the first pair are black and white; (c) ascertaining the color value of the next pair of pages, setting a second temporary variable to a value indicating color if at least one of the pages in the next pair is color, or setting the second temporary variable to a value indicating black and white if both pages in the next pair are black and white; (d) comparing the values of the first and second temporary variables; (e) repeating steps (c) through (e) when the values of the first and second temporary variables are the same, until a mismatch of the values of the first and second temporary variables occurs; (f) returning a result indicating that the source document contains mixed color and black and white pages in response to the fact that the values of the first and second temporary variables are different; and (g) returning a result indicating that the source document does not contain mixed color and black and white pages when a last page of the document is reached but a mismatch of the values of the first and second temporary variables never occurs.

In another aspect, the present invention provides a method for managing a print shop system, the print shop system including a plurality of printers including one or more color printers and one or more black and white printers, the method being implemented on a computer connected to the printers. The method includes the steps of: (a) obtaining a source document to be printed, the source document including a plurality of pages each having a color value indicating whether the page is color or black and white; (b) ascertaining the color value of a first pair of pages, setting a temporary variable to a value indicating the color value of the first pair of page when the color values of both pages are the same; (c) returning a result indicating that the source document contains mixed color and black and white pages when the color values of the first pair of pages are different; (d) ascertaining the color value of a next page; (e) comparing the color value of the next page with the value of the temporary variable; (f) repeating steps (d) through (f) when the color values of the next page and the value of the temporary variable are the same, until a mismatch of the color value of the next page and the value of the temporary variable occurs; (g) returning a result indicating that the source document contains mixed color and black and white pages in response to the fact that the color value of the next page and the value of the temporary variable are different; and (h) returning a result indicating that the source document does not contain mixed color and black and white pages when a last page of the document is reached but a mismatch of the color value of the next page and the value of the temporary variable never occurs.

In yet another aspect, the present invention provides computer program product that includes a computer usable non-transitory medium having a computer readable program code embedded therein for controlling a data processing apparatus, where the computer readable program code is configured to cause the data processing apparatus to execute the above described process for managing a print shop system that has a plurality of printers including one or more color printers and one or more black and white printers connected to the data processing apparatus.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a print shop system having a plurality of printers connected to one or more computers and/or servers directly and/or via a network in which methods according to embodiments of the present invention may be implemented.

FIG. 2 is a flow chart illustrating a method for managing print jobs according to one embodiment of the present invention.

FIG. 3 is a flow chart illustrating a method for managing print jobs according to another embodiment of the present invention.

FIG. 4 schematically illustrates a process according to the one embodiment of the present invention applied to a document having only one color page.

FIG. 5 schematically illustrates a process according to the one embodiment of the present invention applied to a document having only one B/W page.

FIG. 6 schematically illustrates a process according to the one embodiment of the present invention applied to a document having two pages including a color page and a B/W page.

FIG. 7 schematically illustrates a process according to the one embodiment of the present invention applied to a document having two color pages.

FIG. 8 schematically illustrates a process according to the one embodiment of the present invention applied to a document having two B/W pages.

FIG. 9 schematically illustrates a process according to the one embodiment of the present invention applied to a document having multiple mixed pages.

FIG. 10 schematically illustrates a process according to the one embodiment of the present invention applied to a document having multiple B/W pages.

FIG. 11 schematically illustrates a process according to the other embodiment of the present invention applied to a document having only one color page.

FIG. 12 schematically illustrates a process according to the other embodiment of the present invention applied to a document having only one B/W page.

FIG. 13 schematically illustrates a process according to the other embodiment of the present invention applied to a document having two pages including a color page and a B/W page.

FIG. 14 schematically illustrates a process according to the other embodiment of the present invention applied to a document having two color pages.

FIG. 15 schematically illustrates a process according to the other embodiment of the present invention applied to a document having two B/W pages.

FIG. 16 schematically illustrates a process according to the other embodiment of the present invention applied to a document having multiple mixed pages.

FIG. 17 schematically illustrates a process according to the other embodiment of the present invention applied to a document having multiple B/W pages.

FIG. 18 schematically illustrates a process according to the other embodiment of the present invention applied to a document having multiple color pages.

FIG. 19 schematically illustrates a process according to the other embodiment of the present invention applied to a document having multiple mixed pages.

FIG. 20 schematically illustrates a process according to yet another embodiment of the present invention applied to a document having multiple mixed pages to be printed in duplex printing.

### DETAILED DESCRIPTION OF PREFERRED EMBODIMENTS

Embodiments of the present invention provide a method for determine verifying whether a document intended for color-split printing is indeed mixed with both color and B/W pages.

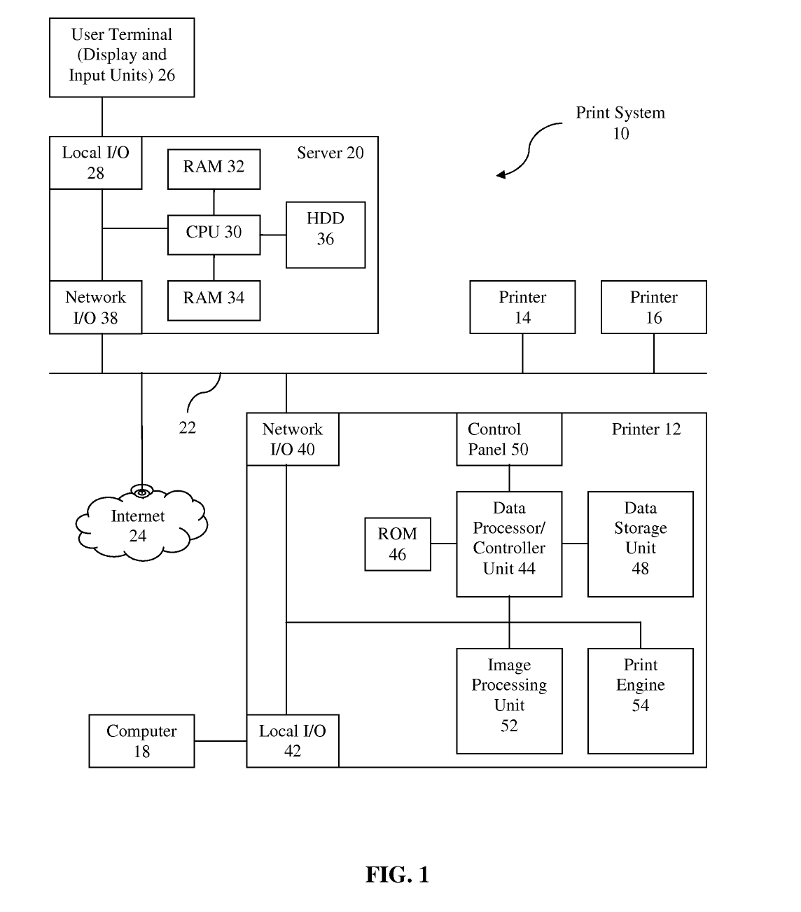

Referring to FIG. 1, a print shop system 10 is schematically shown, where the print shop system 10 include a plurality of color or B/W printers 12, 14, 16, . . . connected to one or more computers 18 and/or servers 20 (or any suitable data processing apparatus) directly or remotely via a data communication channel 22 which may be a wired or wireless network, a dedicated cable or a serial bus connected to the printers. One or more user terminals having a display unit and input unit 26 may be connected to the server 20 to enable print shop operators and/or users to interact with the server 20 and the rest of the system 10. Alternatively the server may have its own integrated display and input units to enable print shop operators and/or users to interact with the system. The server 20 typically includes a local input/output (I/O) port 28 for connection with the user terminal 26, a central processor unit (CPU) 30 that controls the function and operation of the server 20 and execute computer instructions and programs installed or saved on the random access memory (RAM) 32, read only memory (ROM) 34 and/or hard disc drive (HDD) 36 coupled to the CPU 30. The server also has a network I/O port 38 for connection to the data communication channel 22. It is understood that the basic components of the computer 18 are similar to that of the server 20 and therefore will not be repeated in detail here. The server 20 is preferably also connected to an external network 24 such as the Internet for remotely receiving print jobs (i.e. print requests from customers and documents to be printed). The server 20 is remotely connected to the printer 12 via the network input/output (I/O) port 40 of the printer 12, whereas the computer 18 may be directly connected to the printer 12 via the local I/O port 42 of the printer 12.

The basic components of the printers 12, 14 and 16 are also illustrated in printer 12, which include a data processor or controller unit 44 that controls the function and operation of the printer. The controller unit 44 of printer 12 is connected to a ROM 46 and a data storage unit 48. The software program exemplarily implementing the present invention method and process may be installed on the computer 18 or server 20, but may also be installed on ROM 46 or data storage unit 48, which include a non-transitory memory medium, and can be accessed and executed by the controller unit 44. A printer control panel 50 is provided on the printer 12 and accessible by a user and provides a user interface (UI) that includes a display screen such as a liquid crystal display (LCD) display screen and user input devices such as keys, buttons, touch screen, etc., for a user to communicate with the printer 12 and control the functions and operations of printer 12. The printer 12 also has an image processing unit 52 and a print engine 54 that are coupled to and controlled by the controller unit 30.

In a preferred print shop management arrangement, the server 20 is the under control of the print shop management software program, receives print jobs from customers and submits print commands and data to be printed to one or more printers 12, 14 and 16, etc. The print shop management software program may include, among other things, a color-split process which splits a document containing color and B/W pages into a color subset and a B/W subset print, and sends the color subset to a color printer and the B/W subset to a B/W printer. Accordingly, when a document to be printed (sometimes referred to as “the source document”) is mixed with color and B/W pages, the server 20 may first determine as to whether to submit the entire print job (i.e. all pages of the source document) to one or more color printers, or to split the print job into two subsets by submitting the color pages to one or more color printers and the B/W pages to one or more B/W printers. A method for determining whether to split a print job based on a cost calculation to minimize the total cost of printing the entire job is described in commonly owned, co-pending U.S. patent application Ser. No. 11/395,583, filed Mar. 31, 2006, entitled “Print Shop Management Method and Apparatus for Printing Mixed Color and Black and White Documents”, which is incorporated by reference herein in its entirety. Another method for determining whether to split a print job into two sub-jobs that is especially designed for situations where a printing job involves “N-up” printing (multiple pages of the source document to be printed on one sheet of paper), duplex printing (2-sided printing), or mixed paper printing (different paper requirement) is described in commonly owned, co-pending U.S. patent application Ser. No. 11/529,897, filed Sep. 28, 2006, entitled “Print Shop Management Method and Apparatus for Printing Mixed Color and Black and White Documents”, which is also incorporated by reference herein in its entirety.

The method and programs of the embodiments of the present invention address a problem experienced when a user sends a large volume document through color-split printing without knowing for sure whether the document indeed is a mixed document. Sometimes the document has too many pages and the user is unable to preview all the pages, or it is simply too time-consuming for the user to go through all the pages. However, if the document is actually not a mixed document but contains only B/W pages, the color-split program will send all the pages of the document to one or more B/W printers. When the user goes to the printers to collect the printed pages, there will be no page printed by the color printer. Not knowing that the document actually contains no color page, the user may be concerned whether there is some problem in the color printing process. The present invention solves this problem by providing a verification algorithm that pre-determines and advise the user whether a document is mixed with color and B/W pages or not, so the user will not be surprised after the document goes through a color-split printing but only a color or B/W printer or printers are producing output pages.

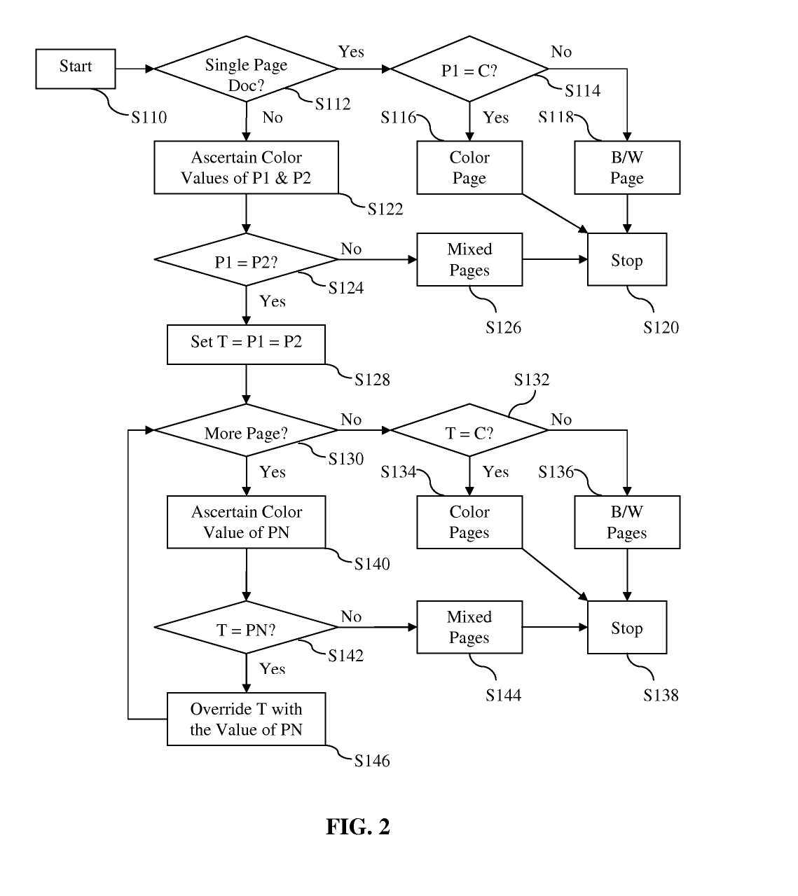

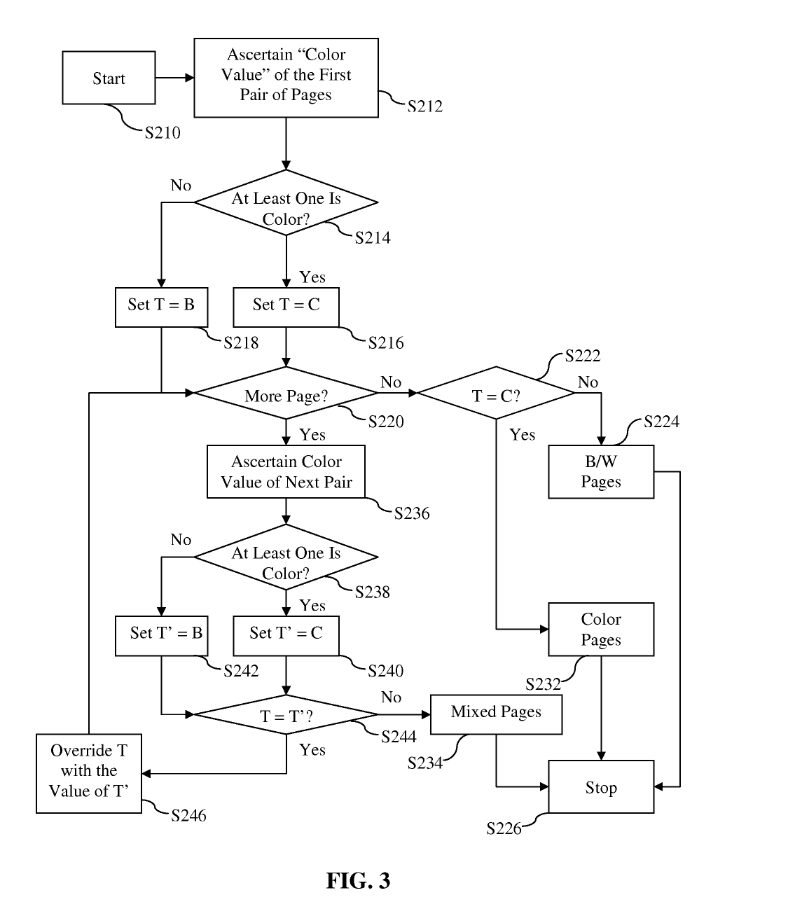

One exemplary embodiment of the present invention is described now with reference to FIGS. 2 and 4-10, and another exemplary embodiment of the present invention will be described later with reference to FIGS. 3 and 11-20. The exemplary process illustrated in FIGS. 2 and 4-10 may be more relevant and executed in connection of a simplex printing procedure, whereas the exemplary process illustrated in FIGS. 3 and 11-20 may be more relevant and executed in connection with a duplex or N-up printing procedure. The present invention processes may be implemented as software or firmware programs executed by the server or computer, or the data processor/controller unit of a printer, or implemented as hardware. Generally a source document (and/or a print job ticket) will contain information about the page color property or “color value” (whether the content is color or B/W) of each page in the document. When N-up and/or duplex printing is involved, pages of the source document may be re-arranged to form the sheets to be printed, and each sheet is designated as either color or B/W to facilitate color-split. In this disclosure, the term “pages” refers to the pages in the source document, and “sheets” refers to sheets of paper of the printed output document, unless otherwise clear from the context. Each sheet to be printed may be composed of multiple pages of the source document and may have one or both sides printed.

Referring to FIG. 2, in one exemplary embodiment of the present invention, when the process starts (step S110), the data processor (which may be the CPU of the computer 18 or server 20 or the controller unit 44 of the printer 12) will check to see whether the source document is a single page document (step S112), if so, the data processor will check to see if it is a color page (step S114). If it is, the data processor will return a result indicating that the document contains one color page (step S116) (so it may be sent to and printed by a color printer), at which point the process stops (step S120). If the data processor determines that the single page is not color at step S114, the data processor will return a result indicating that the document contains one B/W page (step S118) (so it may be sent to and printed by a B/W printer), at which point the process stops (step S120).

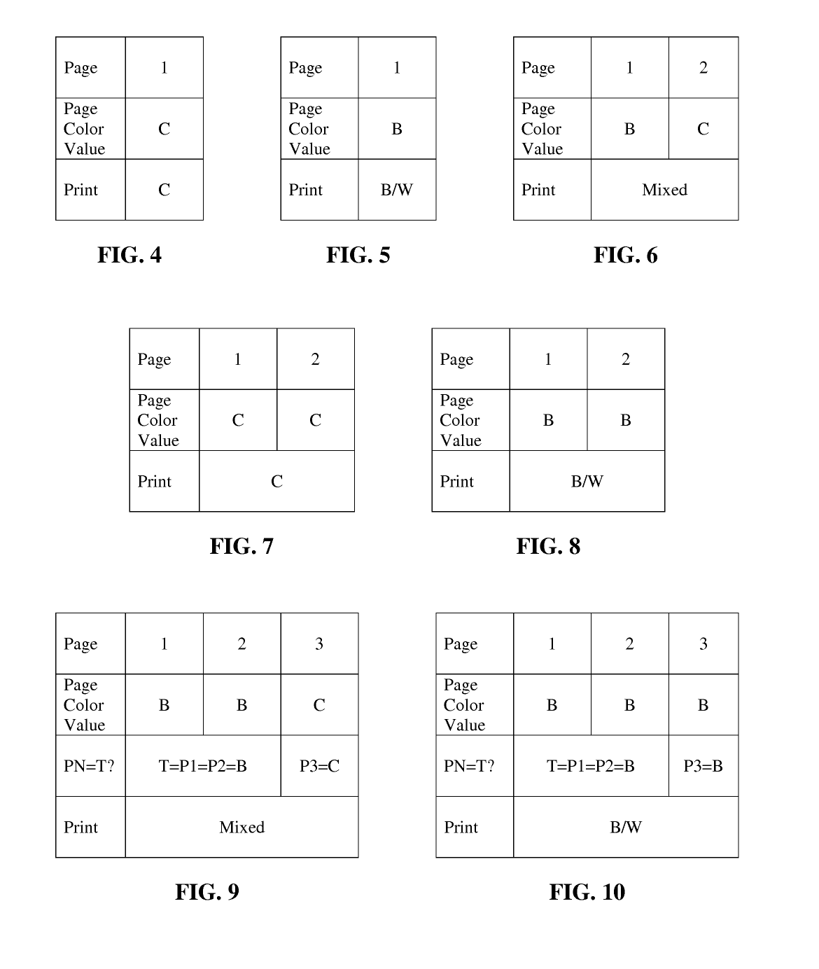

These steps related to a single page document are also illustrated in the examples shown in FIGS. 4 and 5, where a page color value is C for a color page, and B for a B/W page. As described above, the page color values are readily ascertainable from the source document or a print job ticket associated with the source document.

Referring again to FIG. 2, if the data processor determines that the document is not a single page document at step S112, then the color values of the first two pages P1 and P2 are ascertained (step S122) and compared (step S124). If the color values of P1 and P2 are not the same (one is C and the other is B), then the data processor will return a result indicating that the document contains mixed pages (step S126) (so it may be handled by color-split printing), and at which point the process stops (step S120). The data processor needs not go further because it has already verified that the source documents contain mixed pages.

These steps related to a two-page document are also illustrated in the example shown in FIG. 6, where the color values of the first two pages P1 and P2 are different.

Referring again to FIG. 2, if the color values of pages P1 and P2 are the same (both C or both B), then the data processor will set the value of a temporary variable T to be the same as the color value of pages P1 and P2 (step S128), and check to see whether there is more page(s) in the source document (step S130). If there is no more page in the source document, then the data processor check to see if the value of T is C (step S132). If so, it means that both pages are color pages, and the data processor will return a result indicating that the document contains only color pages (step S134) (so it may be sent to and printed by a color printer), and at which point the process stops (step S138). If the data processor finds out that the value of T is not C at step S132, then it means that both pages are B/W pages, and the data processor will return a result indicating that the document contains only B/W pages (step S136) (so it may be sent to and printed by a B/W printer), at which point the process also stops (step S138).

These steps related to a two-page document are also illustrated in the examples shown in FIGS. 7 and 8, where the color values of the two pages are the same.

Referring again to FIG. 2, if the data processor discovers that there are more page(s) in the source document at step S130, then the data processor will ascertain the color value of the next page PN (step S140), and check to see if the value of the temporary variable T is the same as the color value of the next page PN (step S142). If not, it means that mismatch of the color values between the previous pages and the next page PN is found, and the data processor will return a result indicating that the document contains mixed pages (step S144) (so it may be handled by color-split printing), at which point the process stops (step S138).

These steps related to a multi-page document are also illustrated in the example shown in FIG. 9, where the color value of the next page is different from the color values of the previous pages.

Referring again to FIG. 2, if the data processor finds out that value of the temporary variable T is the same as the color value of the next page PN at step S142, then the data processor will override the value of the temporary variable T with the color value of the next page (step S146), and check to see whether there is more page(s) in the source document (step S130). If there is no more page in the source document, then the data processor check to see if the value of T is C (step S132). If so, it means that all pages are color pages, and the data processor will return a result indicating that the document contains only color pages (step S134) (so it may be sent to and printed by a color printer), and at which point the process stops (step S138). If the data processor finds out that the value of T is not C at step S132, then it means that all pages are B/W pages, and the data processor will return a result indicating that the document contains only B/W pages (step S136) (so it may be sent to and printed by a B/W printer), at which point the process also stops (step S138).

These steps related to a multi-page document are also illustrated in the example shown in FIG. 10, where the color value of the next page the same as the color values of the previous pages.

As shown in FIG. 2, the data processor goes through the loop at step S130 to process subsequent pages, but will stop as soon as there is a mismatch in the color values of the pages. This feature means that it is often likely that it is unnecessary to process all the pages in the source document, which makes it a very efficient and time-saving method. In addition, the data processor is designed to utilize a recursive “next-down” scheme, where as soon as the color value of the next page is determined to be the same as the previous ones (saved in the temporary variable T), T is overridden with that color value, so that there is no need to keep the color values of the previous pages in the memory. This saves precious memory space and central processing unit (CPU) resource when executing the program.

Referring now to FIG. 3, in another exemplary embodiment of the present invention, when the process starts (step S210), it will ascertain the color values of the first pair of two pages P1 and P2 (step S212) and compare them (step S216). If at least one of the pages is color, then the data processor will set the value of a temporary variable T to be C (step S216), otherwise (i.e., both pages are B/W) the value of a temporary variable T to be B (step S218). Then the data processor will check to see whether there are more pages in the source document (step S220). If there is no more page in the source document, then the data processor check to see if the value of T is C (step S222). If the value of T is not C, it means that both pages are B/W pages, and the data processor will return a result indicating that the document contains only B/W pages (step S224) (so it may be sent to and printed by a B/W printer), and at which point the process stops (step S226). If the data processor finds out that the value of T is C at step S222, then it will return a result indicating that the document contains color pages (step S232) (so it may be sent to and printed by a color printer), at which point the process will stop (step S226).

When the data processor examining the pages in pairs, the color value of the pair is assigned to as follows:

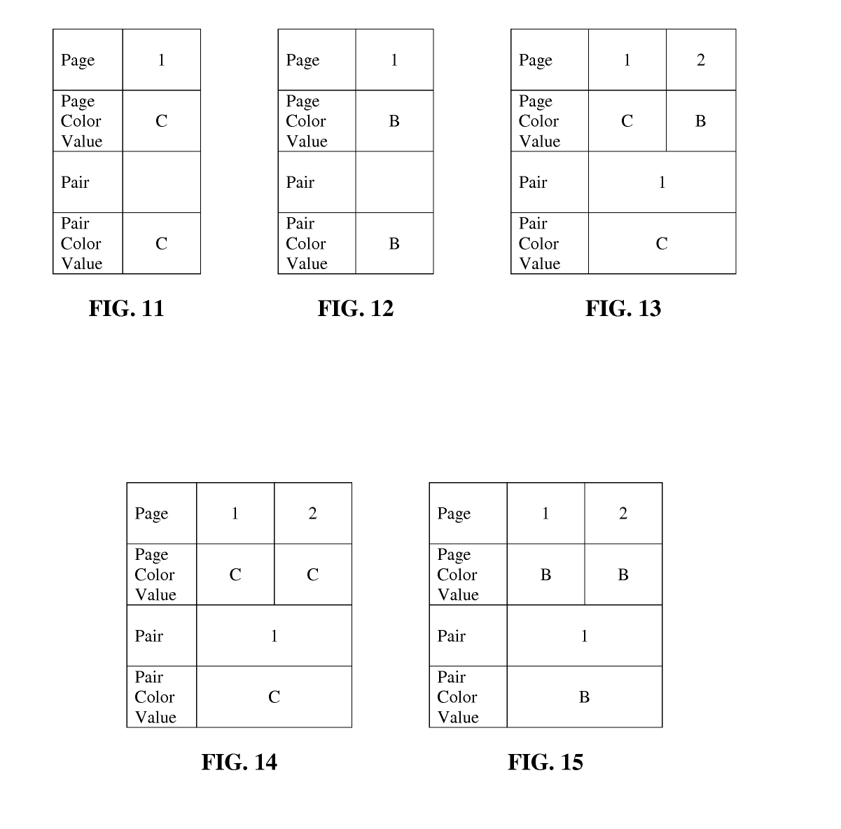

First, if there is only one page in the last-examined pair because the number of pages in the source document is odd, then the color value of the pair will be set to that of the only page in the “pair”. For example, as shown in FIGS. 11 and 12, when the document has only one page, the first pair is the last-examined pair and its color value is the same as the color value of the single page.

Second, when a pair indeed contains two pages, as illustrated in the examples shown in FIGS. 13-15:
If both pages are B/W, then the pair color value is B;
If at least one page is color, then the pair color value is C.
   (It is important to note that when a color value of a pair is C, it only means that at least one of the pages is color, and it does not necessarily mean that both pages are color.)

Referring again to FIG. 3, if the data processor discovers that there are more page(s) in the source document at step S220, then the data processor will ascertain the color value of the next pair of pages (step S236), and check to see if at least one of the pages in the next pair is color (step S238). If at least one of the pages in the next pair is color, then the value of a second temporary variable T′ is set to be C (step S240). If none of the pages in the next pair is color, then the value of the second temporary variable T′ is set to be B (step S242). The data processor then check to see whether the values of the first and second temporary variables T and T′ are equal (step S244). If T is different from T′, it means that a mismatch of the color values between the previous pairs and the next pair of pages has occurred, and the data processor will return a result indicating that the document contains mixed pages (step S234) (so it may be handled by color-split printing), at which point the process stops (step S226).

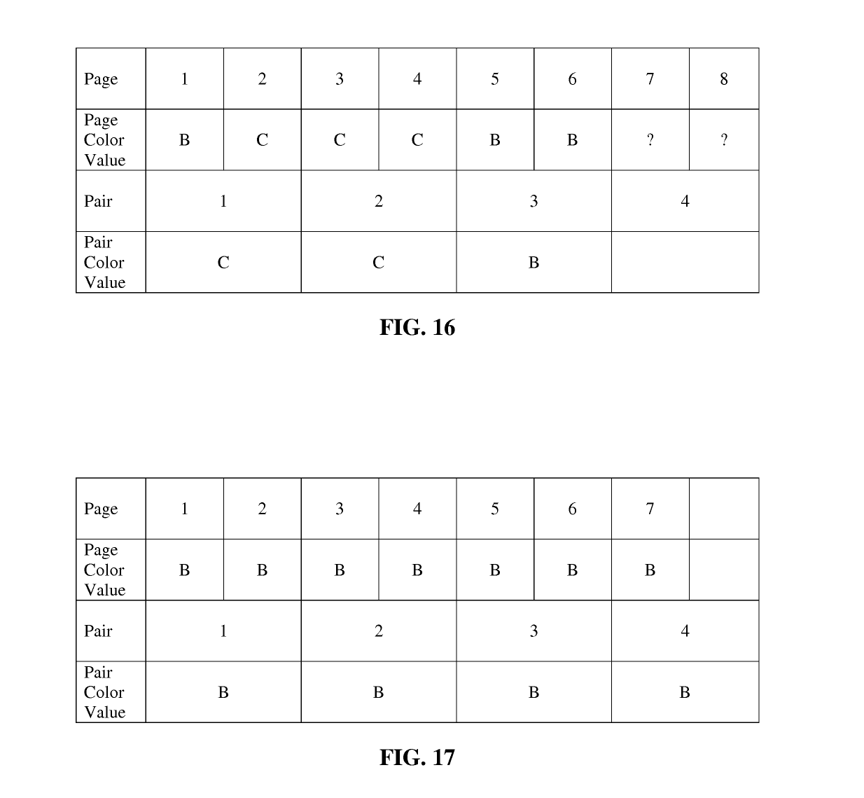

These steps related to a multi-page document are also illustrated in the example shown in FIG. 16, where the color values of the first two pairs of pages does match the color value of the next pair of pages. In this example, the color values of the first two pairs of pages are C, so the first temporary variable T is also set to be C. But the color value of the next pair of pages is B, so the second temporary variable is set to be B. The mismatch of T and T′ indicates that the document is a mixed page document.

Referring again to FIG. 3, if the data processor finds out that value of the first and second temporary variable T and T′ are the same at step S244, then the data processor will override the value of the first temporary variable T with the value of the second temporary variable T′ (step S246), and check to see whether there is more page(s) in the source document (step S220). If there is no more page in the source document, then the data processor check to see if the value of T is C (step S222). If the value of T is not C, it means that all pages are B/W pages, and the data processor will return a result indicating that the document contains only B/W pages (step S224) (so it may be sent to and printed by a B/W printer), and at which point the process stops (step S226).

These steps are illustrated in the example shown in FIG. 17, where the color values of all pairs of pages match (i.e, all are B). In this example, the value of the first temporary variable T (from the first three pairs of pages) is B, and the value of the second temporary variable T′ from the last pair of pages is also B. The matching of T and T′ (not equal to C) indicates that the document contains only B/W pages.

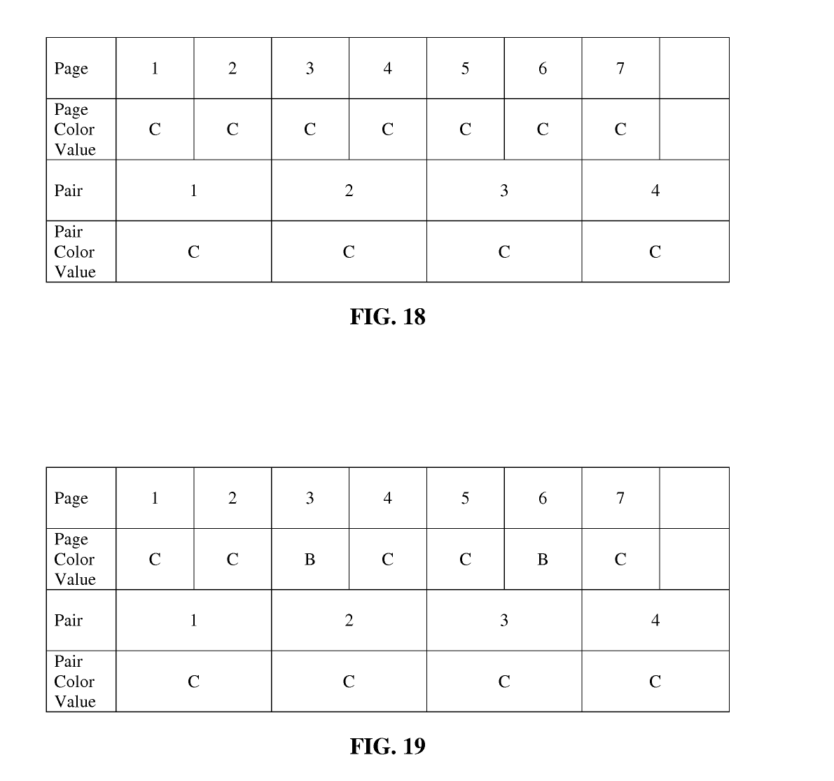

Referring again to FIG. 3, if the data processor finds out that the value of T is C at step S222, then the data processor will return a result indicating that the document contains color pages (step S232) (so it may be sent to and printed by a color printer), at which point the process will stop (step S226). These steps are illustrated in the example shown in FIGS. 18 and 19.

As shown in FIG. 3, the data processor goes through the loop at step S220 to process subsequent pages, but will stop as soon as there is a mismatch in the color values of the pairs of pages. This feature means that it is often likely that it is unnecessary to process all the pages in the source document, which makes it a very efficient and time-saving method.

In addition, this other embodiment of the present invention program is designed to utilize a recursive “pair-down” scheme, where as soon as the value of the second variable T′ (which is set to be the color value of the next pair) is determined to be the same as the first temporary variable T (which is the saved color value of the previous pair), T is overridden with T′, so that there is no need to keep the color values of the previous pairs in the memory. This saves precious memory space and CPU resources when executing the program.

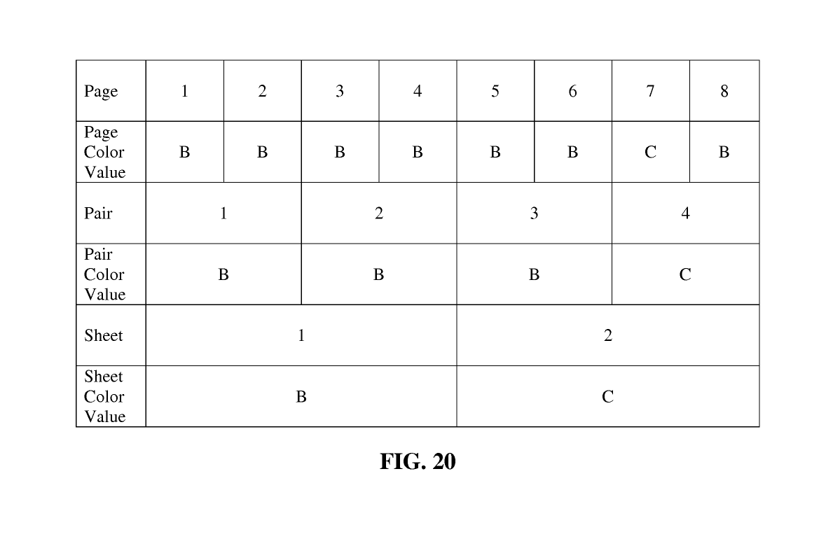

The above described process can also be easily adapted for duplex or other more elaborated printing because of its “pair-down” scheme (e.g., double-sided or two-to-one printing all involve printing two pages of the source document on one sheet of the output printed document). If more pages are to be printed on one sheet, then a multi-tier “pair-down scheme may be utilized. For example, in double-sided two-to-one duplex printing, two pages of the source document are printed on each side of the output printed sheet, so four pages are printed on one sheet. As the example shown in FIG. 20, a source document contains eight pages to be printed on two sheets. After the first “pair-down’ pass, the color value of the four pairs are B, B, B and C. A second-tier “pair-down” can be ran to determine the color value of each sheet (of four pages) so that the data processor can verify on a sheet-level (as versus the page-level) whether color-split is needed.

In the above descriptions, the term “black and white” or “B/W” includes gray scales if the black and white printers are capable of printing gray scale images (e.g. using half-toning or some other suitable method). If, on the other hand, the black and white printers available at a print shop are not capable of printing gray scales, and gray scales must be printed on a color printer, then the server will treat a page with gray scale images as a color page. Further, the methods may be applied in a print shop system that includes monochromic printers, i.e., printers that can print only one color (e.g. only red) or shades of one color. In such a situation, the determination to be made will be whether a source document that contains both full color pages (i.e. pages having more than one color) and monochromic pages are supposed to be printed entirely by a color printer or be split into two sub-jobs, one for a monochromic printer and one for a color printer. (Note that a black and white printer is a monochromic printer.) As another alternative, a print shop may have black and white printers, full color printers, and monochromic printers for a non-black color, and the server will determine whether to print a mixed source document on one, two or more of these printers. More generally, embodiments of the present invention are directed to methods for managing a print shop system that has two or more categories of printers each having a different color capability such as black and white, color or the other examples described above, where the server determines whether to print a document to one, two or more categories of printers based on the complexity of the source document and determines the color designation for each sheet to be printed. When the server analyzes the source document to determine the color characteristics of the sheets, it uses definitions of color categories, e.g., black and white, color, etc., that correspond to the color capabilities of the categories of printers. The definitions of color categories may be programmed into the server software by the operator to suit the need of the particular shop.

While the embodiments have been described as being applied in a print shop environment, the invention is not limited to any physical setting of a shop, and can be applied to a print shop system having a distributed setting where printers at different locations are connected to a server.

It will be apparent to those skilled in the art that various modification and variations can be made to the methods of the present invention without departing from the spirit or scope of the invention. Thus, it is intended that the present invention cover modifications and variations that come within the scope of the appended claims and their equivalents.

What is claimed is:

1. A method for managing a print shop system, the print shop system including a plurality of printers including one or more color printers and one or more black and white printers, the method being implemented on a computer connected to the printers, the method comprising:
(a) obtaining a source document to be printed, the source document including a plurality of pages each having a color value indicating whether the page is color or black and white;
(b) ascertaining the color value of a first pair of pages, setting a first temporary variable to a value indicating color if at least one of the pages in the first pair is color, or setting the first temporary variable to a value indicating black and white if both pages in the first pair are black and white;
(c) ascertaining the color value of the next pair of pages, setting a second temporary variable to a value indicating color if at least one of the pages in the next pair is color, or setting the second temporary variable to a value indicating black and white if both pages in the next pair are black and white;
(d) comparing the values of the first and second temporary variables;
(e) repeating steps (c) through (e) when the values of the first and second temporary variables are the same, until a mismatch of the values of the first and second temporary variables occurs;
(f) returning a result indicating that the source document contains mixed color and black and white pages in response to the fact that the values of the first and second temporary variables are different; and
(g) returning a result indicating that the source document does not contain mixed color and black and white pages when a last page of the document is reached but a mismatch of the values of the first and second temporary variables never occurs.

2. The method of claim 1, wherein two pages in each said pair of pages are printed on a same side of a printed sheet.

3. The method of claim 1, wherein two pages in each said pair of pages are respectively printed on opposite sides of a printed sheet.

4. The method of claim 1, further comprising the step of overriding the value of the first temporary variable with the value of the second temporary variable when the values of the first and second temporary variables are the same.

5. The method of claim 1, further comprising the step of, after a last page of the document is reached without the occurrence of a mismatch of the values of the first and second temporary variables, returning a result indicating that the document contains only black and white pages if the value of the first temporary variable indicates black and white.

6. The method of claim 1, further comprising the step of, after a last page of the document is reached without the occurrence of a mismatch of the values of the first and second temporary variables, returning a result indicating that the document contains at least one color page if the value of the first temporary variable indicates color.

7. A method for managing a print shop system, the print shop system including a plurality of printers including one or more color printers and one or more black and white printers, the method being implemented on a computer connected to the printers, the method comprising:
(a) obtaining a source document to be printed, the source document including a plurality of pages each having a color value indicating whether the page is color or black and white;
(b) ascertaining the color value of a first pair of pages, setting a temporary variable to a value indicating the color value of the first pair of page when the color values of both pages are the same;
(c) returning a result indicating that the source document contains mixed color and black and white pages when the color values of the first pair of pages are different;
(d) ascertaining the color value of a next page;
(e) comparing the color value of the next page with the value of the temporary variable;
(f) repeating steps (d) through (f) when the color values of the next page and the value of the temporary variable are the same, until a mismatch of the color value of the next page and the value of the temporary variable occurs;
(g) returning a result indicating that the source document contains mixed color and black and white pages in response to the fact that the color value of the next page and the value of the temporary variable are different; and
(h) returning a result indicating that the source document does not contain mixed color and black and white pages when a last page of the document is reached but a mismatch of the color value of the next page and the value of the temporary variable never occurs.

8. The method of claim 7, wherein when two pages are printed as a pair, they are printed on a same side of a printed sheet.

9. The method of claim 7, wherein when two pages are printed as a pair, they are respectively printed on opposite sides of a printed sheet.

10. The method of claim 7, further comprising the step of overriding the value of the temporary variable with the color value of the next page when the color value of the next page and the value of the temporary variable are the same.

11. The method of claim 7, further comprising the step of, after a last page of the document is reached without the occurrence of a mismatch of the color value of the next page and the value of the temporary variable, returning a result indicating that the document contains only black and white pages if the value of the temporary variable indicates black and white.

12. The method of claim 7, further comprising the step of, after a last page of the document is reached without the occurrence of a mismatch of the color value of the next page and the value of the temporary variable, returning a result indicating that the document contains at least one color page if the value of the temporary variable indicates color.

13. A computer program product comprising a computer usable non-transitory medium having a computer readable program code embedded therein for controlling a data processing apparatus, the computer readable program code configured to cause the data processing apparatus to execute a process for managing a print shop system, the print shop system including a plurality of printers including one or more color printers and one or more black and white printers connected to the data processing apparatus, the process comprising:
(a) obtaining a source document to be printed, the source document including a plurality of pages each having a color value indicating whether the page is color or black and white;
(b) ascertaining the color value of a first pair of pages, setting a first temporary variable to a value indicating color if at least one of the pages in the first pair is color, or setting the first temporary variable to a value indicating black and white if both pages in the first pair are black and white;
(c) ascertaining the color value of the next pair of pages, setting a second temporary variable to a value indicating color if at least one of the pages in the next pair is color, or setting the second temporary variable to a value indicating black and white if both pages in the next pair are black and white;
(d) comparing the values of the first and second temporary variables;
(e) repeating steps (c) through (e) when the values of the first and second temporary variables are the same, until a mismatch of the values of the first and second temporary variables occurs;
(f) returning a result indicating that the source document contains mixed color and black and white pages in response to the fact that the values of the first and second temporary variables are different; and
(g) returning a result indicating that the source document does not contain mixed color and black and white pages when a last page of the document is reached but a mismatch of the values of the first and second temporary variables never occurs.

14. The computer program product of claim 13, wherein two pages in each said pair of pages are printed on a same side of a printed sheet.

15. The computer program product of claim 13, wherein two pages in each said pair of pages are respectively printed on opposite sides of a printed sheet.

16. The computer program product of claim 13, wherein the process further comprises the step of overriding the value of the first temporary variable with the value of the second temporary variable when the values of the first and second temporary variables are the same.

17. The computer program product of claim 13, wherein the process further comprises the step of, after a last page of the document is reached without the occurrence of a mismatch of the values of the first and second temporary variables, returning a result indicating that the document contains only black and white pages if the value of the first temporary variable indicates black and white.

18. The computer program product of claim 13, wherein the process further comprises the step of, after a last page of the document is reached without the occurrence of a mismatch of the values of the first and second temporary variables, returning a result indicating that the document contains at least one color page if the value of the first temporary variable indicates color.

19. A computer program product comprising a computer usable non-transitory medium having a computer readable program code embedded therein for controlling a data processing apparatus, the computer readable program code configured to cause the data processing apparatus to execute a process for managing a print shop system, the print shop system including a plurality of printers including one or more color printers and one or more black and white printers connected to the data processing apparatus, the process comprising:
(a) obtaining a source document to be printed, the source document including a plurality of pages each having a color value indicating whether the page is color or black and white;
(b) ascertaining the color value of a first pair of pages, setting a temporary variable to a value indicating the color value of the first pair of page when the color values of both pages are the same;
(c) returning a result indicating that the source document contains mixed color and black and white pages when the color values of the first pair of pages are different;
(d) ascertaining the color value of a next page;
(e) comparing the color value of the next page with the value of the temporary variable;
(f) repeating steps (d) through (f) when the color values of the next page and the value of the temporary variable are the same, until a mismatch of the color value of the next page and the value of the temporary variable occurs;
(g) returning a result indicating that the source document contains mixed color and black and white pages in response to the fact that the color value of the next page and the value of the temporary variable are different; and
(h) returning a result indicating that the source document does not contain mixed color and black and white pages when a last page of the document is reached but a mismatch of the color value of the next page and the value of the temporary variable never occurs.

20. The computer program product of claim 19, wherein when two pages are printed as a pair, they are printed on a same side of a printed sheet.

21. The computer program product of claim 19, wherein when two pages are printed as a pair, they are respectively printed on opposite sides of a printed sheet.

22. The computer program product of claim 19, wherein the process further comprises the step of overriding the value of the temporary variable with the color value of the next page when the color value of the next page and the value of the temporary variable are the same.

23. The computer program product of claim 19, wherein the process further comprises the step of, after a last page of the document is reached without the occurrence of a mismatch of the color value of the next page and the value of the temporary variable, returning a result indicating that the document contains only black and white pages if the value of the temporary variable indicates black and white.

24. The computer program product of claim 19, wherein the process further comprises the step of, after a last page of the document is reached without the occurrence of a mismatch of the color value of the next page and the value of the temporary variable, returning a result indicating that the document contains at least one color page if the value of the temporary variable indicates color.
